(19) United States
(12) Patent Application Publication
(10) Pub. No.: US 2024/0191122 A1
(43) Pub. Date: Jun. 13, 2024

(54) RECYCLED WASTE COMPOSITIONS, USES AND PROCESSES OF PREPARING THE SAME

(71) Applicant: Dan Levin, Rehovot (IL)

(72) Inventor: Dan Levin, Rehovot (IL)

(21) Appl. No.: 18/531,758

(22) Filed: Dec. 7, 2023

Related U.S. Application Data
(60) Provisional application No. 63/431,056, filed on Dec. 8, 2022.

(30) Foreign Application Priority Data
Dec. 8, 2022 (IL) 298960

(51) Int. Cl. C09K 5/14; B09B 3/29; B09B 3/35; C01B 3/02; C03C 1/00; C03C 3/062; C03C 3/087; C10J 3/18; F22B 1/02; F28D 20/00

(52) U.S. Cl. CPC C09K 5/14; B09B 3/29; B09B 3/35; C01B 3/02; C03C 1/002; C03C 3/062; C03C 3/087; C10J 3/18; F22B 1/028; F28D 20/0056; C10J 2300/0946; C10J 2300/1223; F28D 2020/0078

(57) ABSTRACT

This invention is directed to recycled waste composition, uses, applications and processes of preparation thereof.

### FIELD OF THE INVENTION

This invention is directed to recycled waste compositions, uses, applications and processes of preparation thereof.

### BACKGROUND OF THE INVENTION

Every year, the world generates over 2 billion tonnes of municipal solid waste, of which, at the very least, 33% is not handled at all and disposed of in landfills or finds its way to open fields or the oceans.

Looking ahead, it is anticipated that worldwide garbage will increase to 3.40 billion tonnes by 2050, more than double the population growth over that time.

Until this day, no comprehensive solution for municipal waste has been present. All of the solutions currently available create waste by products that need future treatment to turn into valuable material or usually disposed of. Integrating advanced technologies for material conversion can allow 100% recycling in municipal waste treatment.

Currently, all municipal treatment options require sorting of the waste and pretreatment before gasification thereof, due to the need to increase energy production.

Waste created at hospitals and medical centers include infectious or biohazardous waste, pathological waste, sharp waste, chemical waste, pharmaceutical & cytotoxic waste and non-hazardous or general medical waste. This medical waste is a cause of a large environmental concern.

Any solvent, sludge, solid or gas that contains: F, Cl, Br, or I is termed “halogenated waste”, which is hazardous waste. Currently, the only treatment for such hazardous waste is incineration, which can cause significant harm for health and environment.

Refinery residue is the hydrocarbon oil remaining after distillates have been removed from petroleum. Currently the only treatment for such hazardous oil refining residues & oil-based wastes is incineration, which can cause significant harm for health and environment.

Contaminated soil waste is a part of land degradation that is caused by the presence of xenobiotic (human-made) chemicals or other alteration in the natural soil environment. It is typically caused by industrial activity, agricultural chemicals or improper disposal of waste. Current treatment requires costly remediation processes that usually do not allow further use of the soil.

Electronic waste (E-Waste) & batteries waste include discarded electrical or electronic devices, including all types of electro-chemical batteries. Batteries and electronic scrap components, such as CPUs, contain potentially harmful materials such as lead, cadmium, beryllium, or brominated flame retardants. Recycling and disposal of e-waste usually involve significant risk to the health of workers and the environment.

Intermediate level radioactive waste (ILW), and Low-level radioactive waste (LLW) are intrinsically radioactive and/or contaminated. Radioactive waste is a result of many activities and fields, including nuclear medicine, nuclear research, nuclear power generation, rare-earth mining, and nuclear weapons reprocessing. Current treatment options usually include burying the waste underground.

Therefore, various and numerous types of wastes are still a major environmental concern as efficient, low cost and green solutions of treatment thereof are yet to be found.

Using energy storage in large capacities can be expensive. Using high energy density materials usually involves costly production. Usually in large capacities, compromises are made and less energy dense materials are used such as salt or water.

Using the same waste stream to create another product, utilized for energy storage systems, can provide a necessary financial benefit that can allow implementation of municipal waste treatment worldwide, without limitations on incoming waste stream. This full cycle recycling process allows for a comprehensive solution for one of humanities biggest problem
waste accumulation.

Thus, there is a need for recycled compositions prepared in a low cost and sustainable process from various wastes (e.g. non sorted municipal waste).

### SUMMARY OF THE INVENTION

In some embodiments, this invention provides a process for the preparation of a recycled non sorted municipal waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, 0-15% w/w ZrO₂ and 0-15% w/w K₂O, wherein the process comprises:
shredding a non sorted municipal waste comprising organic and inorganic waste which was optionally dried before the shredding; and
processing the shredded product to afford the recycled non sorted municipal waste composition.

In one embodiment, the step of processing comprises:
heating the shredded product in an anaerobic environment;
heating further the resulting product with plasma arc burners in a low oxygen environment, providing syngas from the organic waste, and a plasma-treated inorganic waste, wherein the syngas is collected; and
incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled non sorted municipal waste composition.

In some other embodiments, this invention provides a recycled non sorted municipal waste composition, prepared as described hereinabove. In one embodiment, the recycled non sorted municipal waste composition comprises 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, 0-5% w/w ZrO₂ and 0-5% w/w K₂O.

In some other embodiments, this invention provides a composition as described hereinabove, for use in thermal energy storage applications.

In another embodiment, the thermal energy storage applications are selected from the group consisting essentially of: thermal batteries, water heater systems, air heater systems, solar or wind or geothermal or hydrothermal or nuclear power plants, industrial waste heat working according to ORC (Organic-Rankine-Cycle) and intermittent energy buffer.

In some other embodiments, this invention provides a thermal battery comprising the composition as described hereinabove.

In some other embodiments, this invention provides an apparatus for storing and utilizing thermal energy, comprising the battery as described hereinabove; a tubing within or surrounding the battery comprising a condensate inlet and a steam outlet; and, optionally, a tubing within or surrounding the battery, comprising an inlet and an outlet of a hot gas; wherein the steam exits the battery and enters a steam powered device and the condensate exits the steam powered device and enters the battery.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts an apparatus of this invention for storing and utilizing thermal energy.

It will be appreciated that for simplicity and clarity of illustration, elements shown in the FIGURE have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

### Recycled Waste Composition

In one embodiment, this invention is directed to a recycled waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, 0-15% w/w ZrO₂ and 0-15% w/w K₂O. In another embodiment, the composition comprises 30-50% w/w SiO₂, 30-50% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, 0-15% w/w ZrO₂ and 0-15% w/w K₂O. In another embodiment, the composition comprises 30-50% w/w SiO₂, 30-50% w/w CaO, 0-10% w/w MgO, 0-10% w/w Fe₂O₃, 0-10% w/w ZnO, 0-10% w/w Al₂O₃, 0-10% w/w Na₂O, 0-10% w/w TiO₂, 0-10% w/w ZrO₂ and 0-10% w/w K₂O. In another embodiment, the composition comprises 30-60% w/w SiO₂, 30-60% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, 0-15% w/w ZrO₂ and 0-15% w/w K₂O. In another embodiment, the composition comprises 30-60% w/w SiO₂, 30-60% w/w CaO, 0-10% w/w MgO, 0-10% w/w Fe₂O₃, 0-10% w/w ZnO, 0-10% w/w Al₂O₃, 0-10% w/w Na₂O, 0-10% w/w TiO₂, 0-10% w/w ZrO₂ and 0-10% w/w K₂O. In another embodiment, the composition comprises 30-40% w/w SiO₂, 30-40% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, 0-15% w/w ZrO₂ and 0-15% w/w K₂O. In another embodiment, the composition comprises 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, 0-5% w/w ZrO₂ and 0-5% w/w K₂O. In one further embodiment, the composition further comprises 0-5% w/w of other materials, different from the ones indicated hereinabove. Each possibility represents a separate embodiment of this invention.

In some embodiments, the composition of this invention is crystalline. In one embodiment, the composition has 50-99% crystallinity. In another embodiment, the composition has 50-60% crystallinity. In another embodiment, the composition has 50-70% crystallinity. In another embodiment, the composition has 50-80% crystallinity. In another embodiment, the composition has 50-90% crystallinity. In another embodiment, the composition has 60-99% crystallinity. In another embodiment, the composition has 60-70% crystallinity. In another embodiment, the composition has 60-80% crystallinity. In another embodiment, the composition has 60-90% crystallinity. In another embodiment, the composition has 70-99% crystallinity. In another embodiment, the composition has 70-80% crystallinity. In another embodiment, the composition has 70-90% crystallinity. In another embodiment, the composition has 80-99% crystallinity. In another embodiment, the composition has 80-90% crystallinity. In another embodiment, the composition has 90-99% crystallinity. In some embodiments, the recycled waste composition is a recycled non sorted municipal waste composition. Each possibility represents a separate embodiment of this invention.

In some embodiments, the composition of this invention does not comprise microscopic pores. In one embodiment, the composition is not porous. In other embodiment, the composition is porous. In one other embodiment, the composition comprises nanoscale pores. In other embodiments, the composition has a specific surface area of 0.001-3 m²/g. In another embodiment, the specific surface area is of 0.001-0.5 m2/g. In another embodiment, the specific surface area is of 0.001-1 m²/g. In another embodiment, the specific surface area is of 0.001-2 m²/g. In another embodiment, the specific surface area is of 0.5-3 m²/g. In another embodiment, the specific surface area is of 0.5-1 m²/g. In another embodiment, the specific surface area is of 0.5-2 m²/g. In another embodiment, the specific surface area is of 1-3 m²/g. In another embodiment, the specific surface area is of 1-2 m²/g. In another embodiment, the specific surface area is of 2-3 m²/g. Each possibility represents a separate embodiment of this invention.

In some embodiments, the composition of this invention has a tensile strength of above 2 MPa. In one embodiment, the tensile strength is above 4 MPa. In another embodiment, the tensile strength is 2-100 MPa. In another embodiment, the tensile strength is 2-50 MPa. In another embodiment, the tensile strength is 2-20 MPa. In another embodiment, the tensile strength is 2-10 MPa. In another embodiment, the tensile strength is 2-4 MPa. In another embodiment, the tensile strength is 4-100 MPa. In another embodiment, the tensile strength is 4-50 MPa. In another embodiment, the tensile strength is 4-20 MPa. In another embodiment, the tensile strength is 4-10 MPa. In another embodiment, the tensile strength is 10-100 MPa. In another embodiment, the tensile strength is 10-50 MPa. In another embodiment, the tensile strength is 10-20 MPa. In another embodiment, the tensile strength is 20-100 MPa. In another embodiment, the tensile strength is 20-50 MPa. In another embodiment, the tensile strength is 50-100 MPa. Each possibility represents a separate embodiment of this invention.

In some embodiments, the composition of this invention has a specific thermal capacity of 700-1,500 J/Kg° C. In another embodiment, the specific thermal capacity is of 700-800 J/Kg° C. In another embodiment, the specific thermal capacity is of 700-900 J/Kg° C. In another embodiment, the specific thermal capacity is of 700-1,000 J/Kg° C. In another embodiment, the specific thermal capacity is of 700-1,100 J/Kg° C. In another embodiment, the specific thermal capacity is of 700-1,200 J/Kg° C. In another embodiment, the specific thermal capacity is of 700-1,300 J/Kg° C. In another embodiment, the specific thermal capacity is of 700-1,400 J/Kg° C. In another embodiment, the specific thermal capacity is of 800-1,500 J/Kg° C. In another embodiment, the specific thermal capacity is of 800-900 J/Kg° C. In another embodiment, the specific thermal capacity is of 800-1,000 J/Kg° C. In another embodiment, the specific thermal capacity is of 800-1,100 J/Kg° C. In another embodiment, the specific thermal capacity is of 800-1,200 J/Kg° C. In another embodiment, the specific thermal capacity is of 800-1,300 J/Kg° C. In another embodiment, the specific thermal capacity is of 800-1,400 J/Kg° C. In another embodiment, the specific thermal capacity is of 900-1,500J/Kg° C. In another embodiment, the specific thermal capacity is of 900-1,000 J/Kg° C. In another embodiment, the specific thermal capacity is of 900-1,100 J/Kg° C. In another embodiment, the specific thermal capacity is of 900-1,200 J/Kg° C. In another embodiment, the specific thermal capacity is of 900-1,300 J/Kg° C. In another embodiment, the specific thermal capacity is of 900-1,400 J/Kg° C. In another embodiment, the specific thermal capacity is of 1,000-1,500 J/Kg° C. In another embodiment, the specific thermal capacity is of 1,000-1,100 J/Kg° C. In another embodiment, the specific thermal capacity is of 1,000-1,200 J/Kg° C. In another embodiment, the specific thermal capacity is of 1,000-1,300 J/Kg° C. In another embodiment, the specific thermal capacity is of 1,000-1,400 J/Kg° C. In another embodiment, the specific thermal capacity is of 1,100-1,500 J/Kg° C. In another embodiment, the specific thermal capacity is of 1,100-1,200 J/Kg° C. In another embodiment, the specific thermal capacity is of 1,100-1,300 J/Kg° C. In another embodiment, the specific thermal capacity is of 1,100-1,400 J/Kg° C. In another embodiment, the specific thermal capacity is of 1,200-1,500 J/Kg° C. In another embodiment, the specific thermal capacity is of 1,200-1,300 J/Kg° C. In another embodiment, the specific thermal capacity is of 1,200-1,400 J/Kg° C. In another embodiment, the specific thermal capacity is of 1,300-1,500 J/Kg° C. In another embodiment, the specific thermal capacity is of 1,300-1,400 J/Kg° C. In another embodiment, the specific thermal capacity is of 1,400-1,500 J/Kg° C. In one other embodiment, the specific thermal capacity is 1,100 J/Kg° C. Each possibility represents a separate embodiment of this invention.

In some embodiments, the composition of this invention is thermally stable until 1400° C. In one embodiment, the composition is thermally stable until 1300° C. In another embodiment, the composition is thermally stable until 1200° C. In another embodiment, the composition is thermally stable until 1100° C. In another embodiment, the composition is thermally stable until 1000° C. In another embodiment, the composition is thermally stable until 900° C. In another embodiment, the composition is s thermally table until 800° C. In another embodiment, the composition is thermally stable until 700° C. In another embodiment, the composition is thermally stable until 700° C. In another embodiment, the composition is thermally stable until 600° C. In another embodiment, the composition is thermally stable until 500° C. In another embodiment, the composition is thermally stable until 500-600° C. In another embodiment, the composition is thermally stable until 600-700° C. In another embodiment, the composition is thermally stable until 700-800° C. In another embodiment, the composition is thermally stable until 800-900° C. In another embodiment, the composition is thermally stable until 900-1000° C. In another embodiment, the composition is thermally stable until 1000-1100° C. In another embodiment, the composition is thermally stable until 1100-1200° C. In another embodiment, the composition is thermally stable until 1200-1300° C. In another embodiment, the composition is thermally stable until 1300-1400° C. Each possibility represents a separate embodiment of this invention.

In one embodiment, the composition of this invention is used as a thermal storage material and it is used for the same in the temperatures as indicated above, where it is stable.

In some embodiments, the composition of this invention comprises particles having a diameter size of 0.1-15 cm. In one embodiment, the particles have a diameter size of 0.1-1 cm. In another embodiment, the particles have a diameter size of 0.1-3 cm. In another embodiment, the particles have a diameter size of 0.1-5 cm. In another embodiment, the particles have a diameter size of 0.1-10 cm. In another embodiment, the particles have a diameter size of 1-15 cm. In another embodiment, the particles have a diameter size of 1-3 cm. In another embodiment, the particles have a diameter size of 1-5 cm. In another embodiment, the particles have a diameter size of 1-10 cm. In another embodiment, the particles have a diameter size of 3-15 cm. In another embodiment, the particles have a diameter size of 3-5 cm. In another embodiment, the particles have a diameter size of 3-10 cm. In another embodiment, the particles have a diameter size of 5-15 cm. In another embodiment, the particles have a diameter size of 5-10 cm. In another embodiment, the particles have a diameter size of 10-15 cm. Each possibility represents a separate embodiment of this invention.

In some embodiments, the composition of this invention comprises diamond, tubular, sphere, ball, elongated bars or rectangular-shaped particles; or any combination of said shapes. In one embodiment, the composition comprises diamond-shape particles. In another embodiments, the composition comprises diamond-shape particles having a dimeter size of 0.1-15 cm. Each possibility represents a separate embodiment of this invention.

In some embodiments, the composition of this invention is a glassy and inert material.

In some embodiments, the composition of this invention is a recycled material from a non-sorted municipal waste.

In some embodiments, the composition of this invention is low-cost to produce.

In some embodiments, the composition of this invention is non-toxic. In one embodiment, the composition is crystalline and non toxic.

In one embodiment, the composition of this invention is a crystalline, glassy, non-toxic and inert material, and it is recycled from non-sorted municipal waste in a low cost production process.

In some embodiments, the composition of this invention is recycled from non sorted municipal waste, medical waste, halogenated waste, oil refining residues & oil-based wastes, contaminated soil waste, electronic waste (E-Waste) & batteries waste, intermediate level radioactive waste (ILW) and low-level radioactive waste (LLW) or any combination thereof. In one embodiment, the waste is non sorted municipal waste. In other embodiment, the waste is medical waste. In other embodiment, the waste is halogenated waste. In other embodiment, the waste is oil refining residues & oil-based wastes. In other embodiment, the waste is contaminated soil waste. In other embodiment, the waste is electronic waste (E-Waste) & batteries waste. In other embodiment, the waste is intermediate level radioactive waste (ILW) and low-level radioactive waste (LLW). In some other embodiments, any recycled composition of this invention from any source of waste as indicated herein—can accommodate any one or more of the above detailed properties/characteristics—e.g. chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. Each possibility represents a separate embodiment of this invention.

In one embodiment, the composition is a recycled non-sorted municipal waste composition, having at least one of the features as described hereinabove: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the composition is a recycled non-sorted municipal waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the composition is a recycled non-sorted municipal waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the composition is a recycled non-sorted municipal waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the composition is a recycled medical waste composition, having at least one of the features as described hereinabove: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the composition is a recycled medical waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the composition is a recycled medical waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the composition is a recycled medical waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the composition is a recycled halogenated waste composition, having at least one of the features as described hereinabove: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the composition is a recycled halogenated waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the composition is a recycled halogenated waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the composition is a recycled halogenated waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700
1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the composition is a recycled oil refining residues & oil-based wastes composition, having at least one of the features as described hereinabove: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the composition is a recycled oil refining residues & oil-based wastes composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the composition is a oil refining residues & oil-based wastes composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the composition is a recycled oil refining residues & oil-based wastes composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the composition is a recycled contaminated soil waste composition, having at least one of the features as described hereinabove: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the composition is a recycled contaminated soil waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the composition is a recycled contaminated soil waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the composition is a recycled contaminated soil waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the composition is a recycled electronic waste (E-Waste) & batteries waste composition, having at least one of the features as described hereinabove: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the composition is a recycled electronic waste (E-Waste) & batteries waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the composition is a recycled electronic waste (E-Waste) & batteries waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the composition is a recycled electronic waste (E-Waste) & batteries waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the composition is a recycled intermediate level radioactive waste (ILW) and low-level radioactive waste (LLW) composition, having at least one of the features as described hereinabove: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the composition is a recycled intermediate level radioactive waste (ILW) and low-level radioactive waste (LLW) composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the composition is a recycled intermediate level radioactive waste (ILW) and low-level radioactive waste (LLW) composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the composition is a recycled intermediate level radioactive waste (ILW) and low-level radioactive waste (LLW) composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

### Process of Preparing a Recycled Waste Composition

In one embodiment, this invention is directed to a process for the preparation of a recycled waste composition as described hereinabove. In one further embodiment, this invention is directed to a process for the preparation of a recycled waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO 2 and 0-15% w/w K₂O, wherein the process comprises:
Shredding a waste comprising organic and inorganic waste which was optionally dried before the shredding; and
Processing the shredded product to afford the recycled waste composition.

In one other embodiment, the step of processing comprises:
Heating the shredded product in an anaerobic environment;
Heating further the resulting product with plasma arc burners in a low oxygen environment, providing syngas from the organic waste, and a plasma-treated inorganic waste, wherein the syngas is collected; and
Incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled waste composition.

In another embodiment, the step of anaerobically heating the shredded product is termed “pyrolysis”.

In another embodiment, the step of plasma heating is termed “gasification”.

In another embodiment, the step of plasma-treated inorganic waste incorporation in a molten glass bath is termed “vitrification”.

In another embodiment, the step of transferring and cooling the vitrified composition is termed “cooling”.

In some embodiments, the waste utilized (recycled) within the processes of this invention is non sorted municipal waste, medical waste, halogenated waste, oil refining residues & oil-based wastes, contaminated soil waste, electronic waste (E-Waste) & batteries waste, intermediate level radioactive waste (ILW) and low-level radioactive waste (LLW) or any combination thereof. In one embodiment, the waste is non sorted municipal waste. In other embodiment, the waste is medical waste. In other embodiment, the waste is halogenated waste. In other embodiment, the waste is oil refining residues & oil-based wastes. In other embodiment, the waste is contaminated soil waste. In other embodiment, the waste is electronic waste (E-Waste) & batteries waste. In other embodiment, the waste is intermediate level radioactive waste (ILW) and low-level radioactive waste (LLW). In some other embodiments, any recycled composition which is prepared in the processes of this invention can come from any source of waste as indicated herein; and can accommodate any one or more of the above detailed properties/characteristics (see “Recycled Waste Composition” section for further specific details and values)—e.g. chemical composition (SiO₂, CaO, MgO etc. w/w %), % crystallinity, porosity/surface area, tensile strength, specific thermal capacity, (thermal) stability, particles shape/size, non-toxicity, glassy properties, inert, low cost production or any combination of said properties/characteristics. Each possibility represents a separate embodiment of this invention.

In one further embodiment, this invention is directed to a process for the preparation of a recycled non sorted municipal waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO 2 and 0-15% w/w K₂O, wherein the process comprises:
Shredding a waste comprising organic and inorganic waste which was optionally dried before the shredding; and
Processing the shredded product to afford the recycled waste composition.

In one other embodiment, the step of processing comprises:
Heating the shredded product in an anaerobic environment;
Heating further the resulting product with plasma arc burners in a low oxygen environment, providing syngas from the organic waste, and a plasma-treated inorganic waste, wherein the syngas is collected; and
Incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled non-sorted municipal waste composition.

In one further embodiment, this invention is directed to a process for the preparation of a recycled medical waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂ and 0-15% w/w K₂O, wherein the process comprises:
Shredding a waste comprising organic and inorganic waste which was optionally dried before the shredding; and
Processing the shredded product to afford the recycled waste composition.

In one other embodiment, the step of processing comprises:
Heating the shredded product in an anaerobic environment;
Heating further the resulting product with plasma arc burners in a low oxygen environment, providing syngas from the organic waste, and a plasma-treated inorganic waste, wherein the syngas is collected; and
Incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled medical waste composition.

In one further embodiment, this invention is directed to a process for the preparation of a recycled halogenated waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO 2 and 0-15% w/w K₂O, wherein the process comprises:
Shredding a waste comprising organic and inorganic waste which was optionally dried before the shredding; and
Processing the shredded product to afford the recycled waste composition.

In one other embodiment, the step of processing comprises:
Heating the shredded product in an anaerobic environment;
Heating further the resulting product with plasma arc burners in a low oxygen environment, providing syngas from the organic waste, and a plasma-treated inorganic waste, wherein the syngas is collected; and
Incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled halogenated waste composition.

In one further embodiment, this invention is directed to a process for the preparation of a recycled oil refining residues & oil-based wastes composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO 2 and 0-15% w/w K₂O, wherein the process comprises:
Shredding a waste comprising organic and inorganic waste which was optionally dried before the shredding; and
Processing the shredded product to afford the recycled waste composition.

In one other embodiment, the step of processing comprises:
Heating the shredded product in an anaerobic environment;
Heating further the resulting product with plasma arc burners in a low oxygen environment, providing syngas from the organic waste, and a plasma-treated inorganic waste, wherein the syngas is collected; and
Incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled oil refining residues & oil-based wastes composition.

In one further embodiment, this invention is directed to a process for the preparation of a recycled contaminated soil waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO 2 and 0-15% w/w K₂O, wherein the process comprises:
Shredding a waste comprising organic and inorganic waste which was optionally dried before the shredding; and
Processing the shredded product to afford the recycled waste composition.

In one other embodiment, the step of processing comprises:
Heating the shredded product in an anaerobic environment;
Heating further the resulting product with plasma arc burners in a low oxygen environment, providing syngas from the organic waste, and a plasma-treated inorganic waste, wherein the syngas is collected; and
Incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled contaminated soil waste composition.

In one further embodiment, this invention is directed to a process for the preparation of a recycled electronic waste (E-Waste) & batteries waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO 2 and 0-15% w/w K₂O, wherein the process comprises:
Shredding a waste comprising organic and inorganic waste which was optionally dried before the shredding; and
Processing the shredded product to afford the recycled waste composition.

In one other embodiment, the step of processing comprises:
Heating the shredded product in an anaerobic environment;
Heating further the resulting product with plasma arc burners in a low oxygen environment, providing syngas from the organic waste, and a plasma-treated inorganic waste, wherein the syngas is collected; and
Incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled electronic waste (E-Waste) & batteries waste composition.

In one further embodiment, this invention is directed to a process for the preparation of a recycled intermediate level radioactive waste (ILW) and low-level radioactive waste (LLW) composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO 2 and 0-15% w/w K₂O, wherein the process comprises:
Shredding a waste comprising organic and inorganic waste which was optionally dried before the shredding; and
Processing the shredded product to afford the recycled waste composition.

In one other embodiment, the step of processing comprises:
Heating the shredded product in an anaerobic environment;
Heating further the resulting product with plasma arc burners in a low oxygen environment, providing syngas from the organic waste, and a plasma-treated inorganic waste, wherein the syngas is collected; and
Incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled intermediate level radioactive waste (ILW) and low-level radioactive waste (LLW) composition.

In some embodiments, the syngas produced in the gasification step undergoes a cleaning process, before sold as an energy product or used to heat steam and/or drive a turbine to generate electricity. In another embodiment, the syngas is fed to a fuel cell system to produce electricity. In another embodiment the syngas is transferred to various other processes to produce alternative fuels replacing jet fuel, diesel, petrol and other oil based fuels. In another embodiment, the syngas is further processed to produce clean hydrogen, methane, CO₂ and other gaseous products. Each possibility represents a separate embodiment of this invention.

In some embodiments, the waste is shredded in the shredding step to particles of size between 0 and 20 cm. In one embodiment, the shredded particles are of size between 0 and 15 cm. In another embodiment, the shredded particles are of size between 0 and 10 cm. In another embodiment, the shredded particles are of size between 0 and 5 cm. In another embodiment, the shredded particles are of size between 1 and 5 cm. In another embodiment, the shredded particles are of size between 0.5 and 5 cm. In another embodiment, the shredded particles are of size between 1.5 and 5 cm. Each possibility represents a separate embodiment of this invention.

In some embodiments, the step of anaerobically heating the shredded product is described in CN209944342U and EP0149798A3, both of which are incorporated herein by reference.

In some embodiments, the heating in the step of anaerobically heating the shredded product is to 600-1,000° C. In one embodiment, the heating is to 600-700° C. In another embodiment, the heating is to 600-700° C. In another embodiment, the heating is to 600-800° C. In another embodiment, the heating is to 600-900° C. In another embodiment, the heating is to 700-1,000° C. In another embodiment, the heating is to 700-800° C. In another embodiment, the heating is to 700-900° C. In another embodiment, the heating is to 800-1,000° C. In another embodiment, the heating is to 800-900° C. In another embodiment, the heating is to 900-1,000° C. In another embodiment, the heating is to 800° C. Each possibility represents a separate embodiment of this invention.

In some embodiments, the step of plasma heating is described in US20090133407A1, WO2012041019A1 and KR20130136227A; all of which are incorporated herein by reference.

In some embodiments, the heating in the step of plasma heating is to 800-2,000° C. In one embodiment, the plasma heating is to 800-1,900° C. In another embodiment, the plasma heating is to 800-1,800° C. In another embodiment, the plasma heating is to 800-1,700° C. In another embodiment, the plasma heating is to 800-1,600° C. In another embodiment, the plasma heating is to 800-1,500° C. In another embodiment, the plasma heating is to 800-1,400° C. In another embodiment, the plasma heating is to 800-1,300° C. In another embodiment, the plasma heating is to 800-1,200° C. In another embodiment, the plasma heating is to 800-1,100° C. In another embodiment, the plasma heating is to 800-1,000° C. In another embodiment, the plasma heating is to 800-900° C. In another embodiment, the plasma heating is to 900-2,000° C. In another embodiment, the plasma heating is to 900-1,900° C. In another embodiment, the plasma heating is to 900-1,800° C. In another embodiment, the plasma heating is to 900-1,700° C. In another embodiment, the plasma heating is to 900-1,600° C. In another embodiment, the plasma heating is to 900-1,500° C. In another embodiment, the plasma heating is to 900-1,400° C. In another embodiment, the plasma heating is to 900-1,300° C. In another embodiment, the plasma heating is to 900-1,200° C. In another embodiment, the plasma heating is to 900-1,100° C. In another embodiment, the plasma heating is to 900-1,000° C. In another embodiment, the plasma heating is to 1,000-2,000° C. In another embodiment, the plasma heating is to 1,000-1,900° C. In another embodiment, the plasma heating is to 1,000-1,800° C. In another embodiment, the plasma heating is to 1,000-1,700° C. In another embodiment, the plasma heating is to 1,000-1,600° C. In another embodiment, the plasma heating is to 1,000-1,500° C. In another embodiment, the plasma heating is to 1,000-1,400° C. In another embodiment, the plasma heating is to 1,000-1,300° C. In another embodiment, the plasma heating is to 1,000-1,200° C. In another embodiment, the plasma heating is to 1,000-1,100° C. In another embodiment, the plasma heating is to 1,100-2,000° C. In another embodiment, the plasma heating is to 1,100-1,900° C. In another embodiment, the plasma heating is to 1,100-1,800° C. In another embodiment, the plasma heating is to 1,100-1,700° C. In another embodiment, the plasma heating is to 1,100-1,600° C. In another embodiment, the plasma heating is to 1,100-1,500° C. In another embodiment, the plasma heating is to 1,100-1,400° C. In another embodiment, the plasma heating is to 1,100-1,300° C. In another embodiment, the plasma heating is to 1,100-1,200° C. In another embodiment, the plasma heating is to 1,200-2,000° C. In another embodiment, the plasma heating is to 1,200-1,900° C. In another embodiment, the plasma heating is to 1,200-1,800° C. In another embodiment, the plasma heating is to 1,200-1,700° C. In another embodiment, the plasma heating is to 1,200-1,600° C. In another embodiment, the plasma heating is to 1,200-1,500° C. In another embodiment, the plasma heating is to 1,200-1,400° C. In another embodiment, the plasma heating is to 1,200-1,300° C. In another embodiment, the plasma heating is to 1,300-2,000° C. In another embodiment, the plasma heating is to 1,300-1,900° C. In another embodiment, the plasma heating is to 1,300-1,800° C. In another embodiment, the plasma heating is to 1,300-1,700° C. In another embodiment, the plasma heating is to 1,300-1,600° C. In another embodiment, the plasma heating is to 1,300-1,500° C. In another embodiment, the plasma heating is to 1,300-1,400° C. In another embodiment, the plasma heating is to 1,400-2,000° C. In another embodiment, the plasma heating is to 1,400-1,900° C. In another embodiment, the plasma heating is to 1,400-1,800° C. In another embodiment, the plasma heating is to 1,400-1,700° C. In another embodiment, the plasma heating is to 1,400-1,600° C. In another embodiment, the plasma heating is to 1,400-1,500° C. In another embodiment, the plasma heating is to 1,500-2,000° C. In another embodiment, the plasma heating is to 1,500-1,900° C. In another embodiment, the plasma heating is to 1,500-1,800° C. In another embodiment, the plasma heating is to 1,500-1,700° C. In another embodiment, the plasma heating is to 1,500-1,600° C. In another embodiment, the plasma heating is to 1,600-2,000° C. In another embodiment, the plasma heating is to 1,600-1,900° C. In another embodiment, the plasma heating is to 1,600-1,800° C. In another embodiment, the plasma heating is to 1,600-1,700° C. In another embodiment, the plasma heating is to 1,700-2,000° C. In another embodiment, the plasma heating is to 1,700-1,900° C. In another embodiment, the plasma heating is to 1,700-1,800° C. In another embodiment, the plasma heating is to 1,800-2,000° C. In another embodiment, the plasma heating is to 1,800-1,900° C. In another embodiment, the plasma heating is to 1,900-2,000° C. In another embodiment, the plasma heating is to 1,400° C. In another embodiment, the plasma heating is to 1,200° C. Each possibility represents a separate embodiment of this invention.

In some embodiments, the molten glass bath in the vitrification step is heated to the same range of temperatures that are obtained in the plasma heating, as described hereinabove. In one embodiment, the molten glass bath in the vitrification step is heated to the same range of temperatures that are obtained in the plasma heating, but the exact temperature of the molten glass bath and the exact obtained temperature from the plasma in the vitrification and gasification steps, respectively—are different.

In some embodiments, the molten glass bath in the vitrification step contains a molten glass composition prior to the incorporation of the plasma-treated inorganic waste; and said molten glass composition is mixed and/or reacted with said plasma-treated inorganic waste during the vitrification process, while heating (via the plasma arc burners). In one embodiment, the molten glass composition comprises 50-90% w/w SiO₂, 3-30% w/w Na₂O, 3-20% w/w CaO, 0-10% w/w MgO, 0-10% w/w Al₂O₃, 0-10% w/w K₂O, 0-10% w/w Fe₂O₃ and 0-10% w/w TiO₂. In another embodiment, the molten glass composition comprises 60-80% w/w SiO₂, 5-20% w/w Na₂O, 5-15% w/w CaO, 0-5% w/w MgO, 0-5% w/w Al₂O₃, 0-5% w/w K₂O, 0-5% w/w Fe₂O₃ and 0-5% w/w TiO₂. In another embodiment, the molten glass composition further comprises 0-5% w/w of other materials, different from the ones indicated hereinabove. In another embodiment, the molten glass composition comprises 73.2% w/w SiO₂, 13.2% w/w Na₂O, 9.3% w/w CaO, 1.9% w/w MgO, 1.4% w/w Al₂O₃, 0.1% w/w K₂O, 0.1% w/w Fe₂O₃ and 0.3% w/w TiO₂. In yet other embodiments, the molten glass composition has a young modulus of 50-90 GPa. In another embodiment, the young modulus is 50-60 GPa. In another embodiment, the young modulus is 60-70 GPa. In another embodiment, the young modulus is 70-80 GPa. In another embodiment, the young modulus is 80-90 GPa. In another embodiment, the young modulus is 68 GPa. In yet other embodiments, the molten glass composition has a specific gravity of 1-4. In another embodiment, the molten glass composition has a specific gravity of 1-2. In another embodiment, the molten glass composition has a specific gravity of 2-3. In another embodiment, the molten glass composition has a specific gravity of 3-4. In another embodiment, the molten glass composition has a specific gravity of 2.5. In yet other embodiments, the molten glass composition has hardness of 4-10 [Mohs]. In another embodiment, the molten glass composition has hardness of 4-6 [Mohs]. In another embodiment, the molten glass composition has hardness of 6-8 [Mohs]. In another embodiment, the molten glass composition has hardness of 8-10 [Mohs]. In another embodiment, the molten glass composition has hardness of 6-10 [Mohs]. Each possibility represents a separate embodiment of this invention.

In some embodiments, the vitrification process proceeds for 1-2 minutes. In one embodiment, the vitrification process proceeds for 2-10 minutes. In another embodiment, the vitrification process proceeds for 10-50 minutes. In another embodiment, the vitrification process proceeds for 50-120 minutes. In another embodiment, the vitrification process proceeds for 120-480 minutes. Each possibility represents a separate embodiment of this invention.

In some embodiments, the term “room temperature or below” within the cooling step means a temperature of 40° C. or below. In one embodiment, the term “room temperature or below” means a temperature of 10-40° C. In another embodiment, the term “room temperature or below” means a temperature of 15-35° C. In another embodiment, the term “room temperature or below” means a temperature of 35° C. or below. In another embodiment, the term “room temperature or below” means a temperature of 30° C. or below. In another embodiment, the term “room temperature or below” means a temperature of 25° C. or below. In another embodiment, the term “room temperature or below” means a temperature of 20° C. or below. In another embodiment, the term “room temperature or below” means a temperature of 15° C. or below. In another embodiment, the term “room temperature or below” means a temperature of 10° C. or below. In another embodiment, the term “room temperature or below” means 25° C. Each possibility represents a separate embodiment of this invention.

In some embodiments, the compositions is cooled in the cooling step due to the room temperature or below of the canister. In one embodiment, external cooling devices/tubings are employed in order to provide the cooling within the canister.

In some embodiments, the cooling step provides the composition of this invention in a form of a glassy and inert material.

In some embodiments, the step of plasma-treated inorganic waste incorporation in a molten glass bath is described in U.S. Pat. No. 5,637,127A, WO2012041019A1, CN111794701A, CN104310732A, CN110529857A and KR19990080422A; all of which are incorporated herein by reference.

In some embodiments, this invention is directed to a process for the preparation of a recycled non sorted municipal waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, 0-15% w/w ZrO₂ and 0-15% w/w K₂O, wherein the process comprises:
Shredding a non sorted municipal waste comprising organic and inorganic waste which was optionally dried before the shredding; and
Processing the shredded product to afford the recycled waste composition.

In some other embodiments, the shredding, processing and all other elements featured in this process which employs a non sorted municipal waste—are as described hereinabove. In one other embodiment, the recycled composition prepared via the above processes (specifically, via employing non sorted municipal waste) comprises 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, 0-5% w/w ZrO₂ and 0-5% w/w K₂O.

In some embodiments, the composition of this invention is prepared according to any one of the processes as described hereinabove.

In some embodiments, without being bound by any mechanism or theory, it is contemplated that the structure, shape, morphology, density, crystallinity and porosity of the prepared composition according to the above processes of this invention are determined during the various steps of the processes. In one embodiment, the specific integration of the steps into the processes of this invention afford said (structural) parameters. In one other embodiment, in the cooling step, the rate of the cooling and/or the final exact temperature (“room temperature or below”) affect said parameters (structure, shape etc.). In one embodiment, without being bound by any mechanism or theory it is contemplated herein that the beneficial properties associated with the composition of this invention—e.g. high specific thermal capacity and thermal stability are provided due to the specific structure/morphology (e.g. porosity or absence thereof and shapes/dimensions of the particles within the composition) and chemical composition associated with the compositions prepared according to the process of this invention—are provided due to the specific integration of the various steps as described above. In one further embodiment, it is contemplated that the specific utilization of non sorted municipal waste gives rise to the unique characteristics and features of the obtained recycled composition as described hereinabove.

In one embodiment, the recycled composition prepared according to the processes of this invention is a recycled non-sorted municipal waste composition, having at least one of the features as described hereinabove in the “Recycled Waste Composition” section: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the prepared composition is a recycled non-sorted municipal waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the prepared composition is a recycled non-sorted municipal waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1,400° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the prepared composition is a recycled non-sorted municipal waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 (e.g. 1,100) J/Kg° C., the composition is stable until 1,400° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the recycled composition prepared according to the processes of this invention is a recycled non sorted municipal waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O. In another embodiment, the composition comprises 30-40% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O. In another embodiment, the composition comprises 30-80% w/w SiO₂, 30-40% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O. In another embodiment, the composition comprises 30-80% w/w SiO₂, 30-80% w/w CaO, 5-10% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O. In another embodiment, the composition comprises 30-80% w/w SiO₂, 30-80% w/w CaO, 0-15% w/w MgO, 3-5% w/w Fe₂O₃, 0-15% w/w ZnO, 0-15% w/w Al₂O₃, 0-15% w/w Na₂O, 0-15% w/w TiO₂, and 0-15% w/w K₂O. In another embodiment, the composition comprises 30-80% w/w SiO₂, 30-80% w/w CaO, 0-15% w/w MgO, 0-15% w/w Fe₂O₃, 0-5% w/w ZnO, 0-15% w/w Al₂O₃, 0-15% w/w Na₂O, 0-15% w/w TiO₂, and 0-15% w/w K₂O. In another embodiment, the composition comprises 30-80% w/w SiO₂, 30-80% w/w CaO, 0-15% w/w MgO, 0-15% w/w Fe₂O₃, 0-15% w/w ZnO, 0-5% w/w Al₂O₃, 0-15% w/w Na₂O, 0-15% w/w TiO₂, and 0-15% w/w K₂O. In another embodiment, the composition comprises 30-80% w/w SiO₂, 30-80% w/w CaO, 0-15% w/w MgO, 0-15% w/w Fe₂O₃, 0-15% w/w ZnO, 0-15% w/w Al₂O₃, 0-5% w/w Na₂O, 0-15% w/w TiO₂, and 0-15% w/w K₂O. In another embodiment, the composition comprises 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-5% w/w TiO₂, and 0-15% w/w K₂O. In another embodiment, the composition comprises 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-5% w/w K₂O. In another embodiment, the composition comprises 30-40% w/w SiO₂, 30-40% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O. In another embodiment, the composition comprises 30-80% w/w SiO₂, 30-80% w/w CaO, 5-10% w/w MgO, 3-5% w/w Fe₂O₃, 0-15% w/w ZnO, 0-15% w/w Al₂O₃, 0-15% w/w Na₂O, 0-15% w/w TiO₂, and 0-15% w/w K₂O. In another embodiment, the composition comprises 30-40% w/w SiO₂, 30-40% w/w CaO, 5-10% w/w MgO, 3-5% w/w Fe₂O₃, 0-15% w/w ZnO, 0-15% w/w Al₂O₃, 0-15% w/w Na₂O, 0-15% w/w TiO₂, and 0-15% w/w K₂O. In another embodiment, the composition comprises 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, 0-5% w/w ZrO₂ and 0-5% w/w K₂O. Each possibility, property of the composition and/or any combination thereof represents a separate embodiment of this invention.

In some other embodiments of the recycled non sorted municipal waste composition of this invention which is prepared according to the processes of this invention as described hereinabove, the composition is crystalline. In other embodiments, the composition does not comprise microscopic pores. In other embodiments, the composition has a tensile strength of above 2 MPa. In other embodiments, the composition has a specific thermal capacity of 1,000-1,500 J/Kg° C. In other embodiments, the specific thermal capacity is 1,100 J/Kg° C. In other embodiments, the composition is thermally stable until 1400° C. In other embodiments, the composition comprises diamond-shape particles. In other embodiments, the composition comprises particles having a diameter size of 0.1-15 cm. In other embodiments, the composition is porous or not porous and has 50-99% crystallinity. In some other embodiments, the composition is glassy, inert and non-toxic. In other embodiments, the composition is used in thermal energy storage applications. In other embodiments, the thermal energy storage applications are selected from the group consisting essentially of: thermal batteries, water heater systems, air heater systems, solar or wind or geothermal or hydrothermal or nuclear power plants, industrial waste heat working according to Organic-Rankine-Cycle and intermittent energy buffer. In one specific embodiment, a thermal battery comprises said composition. In other embodiment, an apparatus for storing and utilizing thermal energy comprises the thermal battery.

In some embodiments, the recycled non sorted municipal waste composition of this invention is prepared via the process comprising:
Shredding a non sorted municipal waste comprising organic and inorganic waste which was optionally dried before the shredding; and
Processing the shredded product to afford the recycled waste composition.

In one embodiment, the processing step comprises:
Heating the shredded product in an anaerobic environment;
Heating further the resulting product with plasma arc burners in a low oxygen environment, providing syngas from the organic waste, and a plasma-treated inorganic waste, wherein the syngas is collected; and
Incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled waste composition.

In one further embodiment, the heating in the step of anaerobically heating the shredded product is to 600-1,000° C. In another embodiment, the heating in the step of anaerobically heating the shredded product is to 800° C.

In one further embodiment, the heating in the step of plasma heating is to 800-2,000° C. In another embodiment, heating in the plasma heating is to 1,400° C.

In one embodiment, the recycled composition prepared according to the processes of this invention is a recycled medical waste composition, having at least one of the features as described hereinabove in the “Recycled Waste Composition” section: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the prepared composition is a recycled medical waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the prepared composition is a recycled medical waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the prepared composition is a recycled medical waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the recycled composition prepared according to the processes of this invention is a recycled halogenated waste composition, having at least one of the features as described hereinabove in the “Recycled Waste Composition” section: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the prepared composition is a recycled halogenated waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the prepared composition is a recycled halogenated waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the prepared composition is a recycled halogenated waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the recycled composition prepared according to the processes of this invention is a recycled oil refining residues & oil-based wastes composition, having at least one of the features as described hereinabove in the “Recycled Waste Composition” section: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the prepared composition is a recycled oil refining residues & oil-based wastes composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the prepared composition is a recycled oil refining residues & oil-based wastes composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the prepared composition is a recycled oil refining residues & oil-based wastes composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the recycled composition prepared according to the processes of this invention is a recycled contaminated soil waste composition, having at least one of the features as described hereinabove in the “Recycled Waste Composition” section: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the prepared composition is a recycled contaminated soil waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the prepared composition is a recycled contaminated soil waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the prepared composition is a recycled contaminated soil waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the recycled composition prepared according to the processes of this invention is a recycled electronic waste (E-Waste) & batteries waste composition, having at least one of the features as described hereinabove in the “Recycled Waste Composition” section: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the prepared composition is a recycled electronic waste (E-Waste) & batteries waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the prepared composition is a recycled electronic waste (E-Waste) & batteries waste composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the prepared composition is a recycled electronic waste (E-Waste) & batteries waste composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

In one embodiment, the recycled composition prepared according to the processes of this invention is a recycled intermediate level radioactive waste (ILW) and low-level radioactive waste (LLW) composition, having at least one of the features as described hereinabove in the “Recycled Waste Composition” section: chemical composition (SiO₂, CaO, MgO etc. w/w %), % crystallinity, porosity/surface area, tensile strength, specific thermal capacity, (thermal) stability, particles shape/size, non-toxicity, glassy properties, inert, and low cost production. In one further embodiment, the prepared composition is a recycled intermediate level radioactive waste (ILW) and low-level radioactive waste (LLW) composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, the composition is glassy, inert, non-toxic or any combination of the aforementioned properties listed herein. In another embodiment, the prepared composition is a recycled intermediate level radioactive waste (ILW) and low-level radioactive waste (LLW) composition, comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, and 0-15% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond, tubular, sphere, ball, elongated bars or rectangular shaped particles having a diameter size of 0.1-15 cm, the composition is used as a thermal storage material, and the composition is glassy, inert and non-toxic. In another embodiment, the prepared composition is a recycled intermediate level radioactive waste (ILW) and low-level radioactive waste (LLW) composition, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, and 0-5% w/w K₂O, wherein the composition is porous or not porous and has 50-99% crystallinity, has a tensile strength of above 2 MPa, has a specific thermal capacity of 700-1,500 J/Kg° C., the composition is stable until 1000° C., the composition comprises diamond shaped particles having a diameter size of 0.1-15 cm, the composition is used as a thermal storage material, and the composition is glassy, inert and non-toxic. Each possibility, property of the composition and/or any combination thereof represents a separate embodiment of this invention.

### Uses and Applications of the Recycled Waste Compositions

In one embodiment, this invention is directed to the composition as described hereinabove for use in thermal energy storage applications. In other embodiments, non-limiting examples of the thermal energy storage applications are selected from the group consisting essentially of: thermal batteries, water heater systems, air heater systems, solar or wind or geothermal or hydrothermal or nuclear power plants, industrial waste heat working according to ORC (Organic-Rankine-Cycle) and intermittent energy buffer.

In some embodiments, this invention is directed to a thermal battery (also known as a “solid thermal energy storage” (STES) comprising the composition as described hereinabove.

In some embodiments, this invention is directed to water heater systems comprising the composition, the thermal battery or both composition and battery of this invention, as described hereinabove.

In some embodiments, this invention is directed to air heater systems comprising the composition, the thermal battery or both composition and battery of this invention, as described hereinabove.

In some embodiments, this invention is directed to solar or wind or geothermal or hydrothermal or nuclear power plants, comprising the composition, the thermal battery or both composition and battery of this invention, as described hereinabove.

In some embodiments, this invention is directed to industrial waste heat working according to ORC (Organic-Rankine-Cycle) comprising the composition, the thermal battery or both composition and battery of this invention, as described hereinabove.

In some embodiments, this invention is directed to intermittent energy buffer comprising the composition, the thermal battery or both composition and battery of this invention, as described hereinabove.

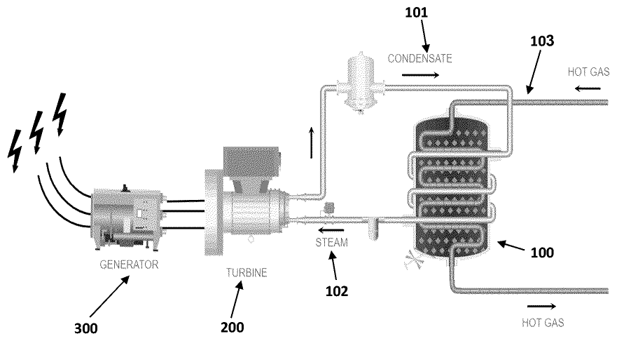

In one embodiment, this invention is directed to an apparatus for storing and utilizing thermal energy, comprising the battery as described hereinabove (100, FIG. 1); a tubing within or surrounding the battery comprising a condensate inlet (101) and a steam outlet (102); and, optionally, a tubing (103) within or surrounding the battery, comprising an inlet and an outlet of a hot gas; wherein the steam exits the battery and enters a steam powered device and the condensate exits the steam powered device and enters the battery. In another embodiment, the hot gas can come from any thermal process/other apparatus coupled to said apparatus of this invention. In another embodiment, the steam powered device is a turbine (200), a steam engine or any other device capable of utilizing mechanical work of steam, as known in the art. In another embodiment, the steam powered device is connected to a generator (300). In another embodiment, the steam powered device is a turbine and said turbine is connected to a generator. Each possibility represents a separate embodiment of this invention.

In one embodiment, this invention is directed to a method of storing and utilizing thermal energy, comprising heating the battery of the apparatus as described hereinabove, providing stored thermal energy in the battery. In one other embodiment, this invention is directed to a method of storing and utilizing thermal energy, comprising:
preparing the recycled composition of this invention, where the process of preparation, steps thereof and any embodiments associated thereof are described hereinabove;
providing an apparatus comprising a thermal battery which comprises the prepared recycled composition; and
heating the battery of the apparatus, providing stored thermal energy in the battery.
   In another embodiment, the recycled composition is any one as described hereinabove or hereinbelow. In one other embodiment, the recycled composition is a recycled non sorted municipal waste composition.

In some other embodiments, the heating within the method of storing and utilizing thermal energy is done via hot gas induction tunneled through the tubing in the battery of the apparatus. In yet another embodiment, the heating is performed via electrical heating and/or via solar heating, or from waste heat from incinerators, other thermal processes, wind energy or any other type of energy source. In another embodiment, the method further comprises utilization of the stored thermal energy, via the steam of said apparatus which is allowed to exit the battery and enter the steam powered device of said apparatus, performing a mechanical work. In another embodiment, the steam in the steam powered device exits from the device as condensate and enters back to the battery.

In one embodiment, the apparatus comprises an insulated storage tank (a thermal battery), filled with the composition of this invention, and wherein the storage tank comprises a plurality of metal tubes (comprising inlets/outlets) inside the tank, maximizing the contact of a fluid or a gas going through them and the composition of this invention. In another embodiment, the pipes inside the tank are covered with heat elements, that can heat both the content of the pipes and the composition in contact with the pipes in the storage tank. In another embodiment, around the tank there is another set of pipes to flow water and heat them to make steam. In another embodiment, the external pipes are connected to a steam generator to produce steam. In another embodiment, the steam generator is connected to a steam turbine to produce electricity. In another embodiment, the internal pipes can be used for carrying waste heat from thermal processes and utilize them to heat the composition of this invention, thus preserving the waste heat to be used as electricity when needed. In other embodiments, the steam pipes can be directly fed to a consumer (steam powered device) to supply energy as steam.

In some embodiments, when hot gas is induced in the internal pipes of the system (STES), sensible heat can be efficiently stored in the composition of this invention. Due to the high melting point of the composition, high temperatures can be reached, thus increasing the potential energy storage capacity. In one embodiment, the heat is stored for a period of time (e.g. days) and utilized upon demand (e.g. by letting the steam out of the STES and into the steam powered devices).

In some embodiments, the hot gas can be sourced in (can come from) any thermal process. Alternatively, electric heating can be used to store energy in the system. The source for heating the thermal battery (and composition) of this invention can be solar energy, waste heat from incinerators or other thermal processes, wind energy and any other type of energy source as known in the art.

In some embodiments, when heated, the composition of this invention can store the energy to be used when needed, at peak hours or at night time, when solar energy production is unavailable.

In one embodiment, an example of an apparatus of this invention is presented in FIG. 1.

In some embodiments, the composition, uses and applications (e.g. thermal battery and apparatus comprising the same) of this invention comprise the at least one of the following advantageous features:
Low-cost raw material, as municipal waste is used to produce the recycled composition, therefore receiving gate fee for processing waste;
Reducing greenhouse gas (GHG) emissions by diverting municipal waste from landfills, requiring extensive land and logistics that incur environmental damage and large costs;
High heat capacity (>700 J/Kg° C.);
Single tank system reduces the capital costs of the energy storage system;
Simple design, easily maintained and long-lasting. The invention has the benefits of a simple design, easy maintenance and use, and a broad range of potential applications;
High heat resistance (up to 1,400 Celsius);
Extensive lifespan—the composition remains stable even after multiple cycles and can possibly remain in efficient working conditions for decades;
Multiple stage thermal preparation of the waste to create the recycled composition grant unique physical and chemical properties that enhance energy density (Pyrolysis-Gasification-Vitrification); and
The recycled composition is inert—i.e. it allows gas or liquid to go through stacked material without contamination.
   Each possibility, feature or any combination thereof represents a separate embodiment of this invention.

In some embodiments, the processes of this invention provide the recycled non sorted municipal waste compositions as described hereinabove, and these compositions feature unique thermal stability profile. In one embodiment, this profile was characterized via e.g. differential scanning calorimeter (DSC). In such characterization, it was found, in one further embodiment, that said compositions are stable until 1,400° C.; at which temperature the composition melts. In one further embodiment, when heating the compositions from room temperature, the heat capacity was increased from room temperature up to around 100 degrees Celsius, then it stayed stable with a slight increase after 300 degrees Celsius. Calculated average specific heat of the material was around 1,100 J/Kg° C. The material was thermally stable throughout the testing range, up to 500 Celsius and it is melted around 1400° C., thus it is suitable for thermal energy storage purposes. In some embodiments, without being bound to any mechanism or theory, it is herein contemplated that the unique thermal (and other) properties associated with the recycled non-sorted municipal waste composition result from the specific integration of all process parameters as found in the processes of this invention, e.g. employing non sorted (municipal) waste and other steps involving shredding of said waste and processing of said shredded waste, as described hereinabove. In one further embodiment, the mechanical properties as described hereinabove (e.g. tensile strength of above 2 MPa) also result from said specific integration of all process parameters. Each possibility, feature or any combination thereof represents a separate embodiment of this invention.

In some embodiments, without being bound by any mechanism or theory, it is contemplated that the structure, shape, morphology, density, crystallinity and porosity of the recycled non sorted waste composition according to the above processes of this invention are determined during the various steps of the processes. In one embodiment, the specific integration of the steps (including, but not limited to the step of provision of a non sorted municipal waste) into the processes of this invention afford said (structural) parameters. In one other embodiment, in the cooling step, the rate of the cooling and/or the final exact temperature (“room temperature or below”) affect said parameters (structure, shape etc.). In one further embodiment, said parameters (structure, shape etc.) provide the very specific thermal profile and characteristics of the obtained recycled non sorted municipal waste composition. Hence, the choice of specifically municipal waste, without sorting thereof, and other various processing steps within the processes of this invention—lead to the structure, shape, morphology, density, crystallinity and porosity of the obtained compositions and these inherent structural properties of the composition (structure, shape, morphology, etc.) in turn provide, alone or in combination—the thermal and mechanical profile and characteristics of the compositions of this invention. Specifically, in one embodiment, these structural inherent properties include, without limitation, actual percentage composition as described hereinabove (non-limiting example is an embodiment where the composition comprises 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, 0-5% w/w ZrO₂ and 0-5% w/w K₂O), 50-99% crystallinity, absence of microscopic pores, diamond-shaped particles, particles diameter size of 0.1-15 cm, and glassy, inert and/or non-toxic characteristics; and each one or any combination of said properties (e.g. one of them, some of them or all of them) lead to the thermal and mechanical profile/properties (e.g. tensile strength of above 2 MPa) of the composition of this invention, specifically the recycled non sorted municipal waste composition. Each possibility, feature or any combination thereof represents a separate embodiment of this invention.

### Definitions

In some embodiments, the term “low oxygen environment” in the context of the processes of this invention refers to a gas comprising 10-16% w/w 02. In one embodiment, the gas comprises 10-16% w/w O₂ and 25-90% w/w N₂. In another embodiment, the gas comprises 10-16% w/w O₂, 25-90% w/w N₂ and 10-80% w/w CO. In another embodiment, the gas further comprises 0-30% w/w CO₂, 0-50% w/w H₂ and 0-20% w/w CH₄. In another embodiment, the gas comprises 10-16% w/w O₂ and 25-50% w/w N₂. In another embodiment, the gas comprises 10-16% w/w O₂ and 50-75% w/w N₂. In another embodiment, the gas comprises 10-16% w/w O₂ and 75-90% w/w N₂. In another embodiment, the gas comprises 10-16% w/w O₂, 25-90% w/w N₂ and 10-40% w/w CO. In another embodiment, the gas comprises 10-16% w/w O₂, 25-90% w/w N₂ and 40-60% w/w CO. In another embodiment, the gas comprises 10-16% w/w O₂, 25-90% w/w N₂ and 60-80% w/w CO. Each possibility represents a separate embodiment of this invention.

In some embodiments, the term “thermally stable composition” in the context of the composition of this invention means that the composition can be used in thermal energy storage applications at the indicated temperatures; and can be used effectively for numerous cycles of “charging”/“discharging” (thermally) within a thermal battery. In this context, the term “the composition is thermally stable until temperature T” means that the composition is stable (as “thermal stability” is defined above) from the beginning of the stability measurement, usually when the composition is solid and at room temperature (see “room temperature” definition below) and until said temperature “T”. The temperature range of thermal stability is thus, at least from room temperature until temperature “T”. In some embodiments, it is considered that the composition is stable until its melting point (temperature), hence “T” temperature, in some such embodiments, is the actual melting temperature of the composition. Each possibility represents a separate embodiment of this invention.

In some embodiments, the terms “the composition” or “the recycled composition” are interchangeable, and meaning the compositions of this invention, as described herein.

In some embodiments, the term “room temperature” means the temperature of the environment at which the experiment/study was performed. In one embodiment, the “room temperature” is 10-35° C. In another embodiment, the “room temperature” is 10-30° C. In another embodiment, the “room temperature” is 10-25° C. In another embodiment, the “room temperature” is 10-20° C. In another embodiment, the “room temperature” is 15-40° C. In another embodiment, the “room temperature” is 15-35° C. In another embodiment, the “room temperature” is 15-30° C. In another embodiment, the “room temperature” is 15-25° C. Each possibility represents a separate embodiment of this invention.

In some embodiments, the term “recycled X waste/wastes composition” used throughput the subject application refers to a composition prepared via recycling of the waste “X”, wherein X is selected from the non limiting group consisting of: non sorted municipal waste, medical waste, halogenated waste, oil refining residues & oil-based wastes, contaminated soil waste, electronic waste (E-Waste) & batteries waste, intermediate level radioactive waste (ILW) and low-level radioactive waste (LLW) and any combination thereof.

Various embodiments and aspects of the present invention as delineated hereinabove and as claimed in the claims section below find experimental support in the following examples.

### EXAMPLES

### Example 1

Preparation of a Recycled Non-Sorted Municipal Waste Composition of this Invention

### Stage 1—Preparation

Mixed, non-sorted municipal waste comprising organic and inorganic materials was dried, if necessary, and shredded to small particles <5 cm.

### Stage 2—Pyrolysis

The shredded waste was heated up to 600-900 Celsius without the presence of oxygen to prevent combustion.

### Stage 3—Gasification

The pyrolized waste was heated up to 1,200-1,400 Celsius using plasma arc burners, with limited oxygen to prevent combustion. The limited oxygen environment comprised 10-16% w/w O₂, 25-90% w/w N₂, 10-80% w/w CO, 0-30% w/w CO₂, 0-50% w/w H₂ and 0-20% w/w CH₄. In this process the organic material was gasified to syngas and utilized for energy production. The plasma-treated inorganic material followed to the next stage.

### Stage 4—Vitrification and Cooling

The plasma treated inorganic waste was incorporated at 1,300-2,000 Celsius in a molten glass bath by vitrification process, to create a unified inert glassy material. The molten glass, prior to the incorporation of the plasma treated inorganic waste had a composition comprising 73.2% w/w SiO₂, 13.2% w/w Na₂O, 9.3% w/w CaO, 1.9% w/w MgO, 1.4% w/w Al₂O₃, 0.1% w/w K₂O, 0.1% w/w Fe₂O₃ and 0.3% w/w TiO₂; and young modulus of 68 GPa, specific gravity—2.5 and Hardness of above 6 [Mohs]. The molten glassy material exited the reactor to be cooled in a separate canister at room temperature and was crystallized into small (diamond-like shaped) particles up to several centimeters in diameter.

### Example 2

### Characterization of the Composition of Example 1

Elemental analysis of the composition of Example 1 was performed using X-ray fluorescence (XRF) analyzer, with the results presented in Table 1.

TABLE 1
Typical composition of the waste crystals, represented as % mass

| SiO2 | CaO | MgO | Fe2O3 | ZnO | ZrO2 | Al2O3 | Na2O | TiO | K2O | rest |
|---|---|---|---|---|---|---|---|---|---|---|
| 30-40 | 30-40 | 5-10 | 3-5 | -0-5 | -0-5 | 0-5 | 0-5 | 0-5 | 0-5 | 0-5 |

To evaluate the thermal heat capacity and stability of the samples, differential scanning calorimeter (DSC) analysis was performed by heating the sample from room temperature up to 500 Celsius.

Specific heat of the sample was increased up to around 100 Celsius, then it stayed stable with a slight increase after 300 degrees Celsius. Calc. Average specific heat of the material was around 1,100 J/Kg° C.

The material was thermally stable throughout the testing range, up to 500 Celsius and it was melted around 1400° C., thus it is suitable for thermal energy storage purposes.

### Example 3

### A Thermal Energy Storage System/Apparatus Comprising the Composition of Example 1

A thermal energy storage system (or “apparatus”) is constructed.

The system comprises:
Insulated storage tank (“a thermal battery”), filled with the composition of Example 1;
A plurality of metal tubes inside the tank, maximizing the contact of a fluid or a gas going through them and the composition;
Heat elements covering the pipes. The heat elements heat both the content of the pipes and the composition in contact with the pipes in the storage tank; and
Another set of pipes to flow water and heat them to make steam.
   The external pipes are connected to a steam generator to produce steam.
   The steam generator is connected to a steam turbine to produce electricity.
   The internal pipes is used for carrying waste heat from thermal processes and utilize them to heat the composition, thus preserving the waste heat to be used as electricity when needed.
   The steam pipes can be directly fed to a consumer to supply energy as steam.

When hot gas is induced in the internal pipes of the system, sensible heat can be efficiently stored in the composition. Due to the high melting point of the composition, high temperatures can be reached, thus increasing the potential energy storage capacity.

The hot gas can be sourced in any thermal process. Alternatively, electric heating can be used to store energy in the system. The source for heating the crystals can be solar energy, waste heat from incinerators or other thermal processes, wind energy and any other type of energy source.

When heated, the composition stores the energy to be used when needed, at peak hours or at night time, when solar energy production is unavailable.

While certain features of this invention have been illustrated and described herein, many modifications, substitutions, changes, and equivalents will now occur to those of ordinary skill in the art. It is, therefore, to be understood that the appended claims are intended to cover all such modifications and changes as fall within the true spirit of this invention.

What is claimed is:

1. A process for the preparation of a recycled non sorted municipal waste composition comprising 30-80% w/w SiO₂, 30-80% w/w CaO, 0-15% w/w MgO, 0-15% w/w Fe₂O₃, 0-15% w/w ZnO, 0-15% w/w Al₂O₃, 0-15% w/w Na₂O, 0-15% w/w TiO₂, 0-15% w/w ZrO₂ and 0-15% w/w K₂O, wherein the process comprises:
shredding a non sorted municipal waste comprising organic and inorganic waste which was optionally dried before the shredding; and
processing the shredded product to afford the recycled non sorted municipal waste composition.

2. The process of claim 1, wherein the step of processing comprises:
heating the shredded product in an anaerobic environment;
heating further the resulting product with plasma arc burners in a low oxygen environment, providing syngas from the organic waste, and a plasma-treated inorganic waste, wherein the syngas is collected; and
incorporating the plasma-treated inorganic waste in a molten glass bath which is heated via the plasma arc burners to form a vitrified composition; and
transferring the vitrified composition to a separate canister and cooling the vitrified composition to room temperature or below and affording the recycled non sorted municipal waste composition.

3. The process of claim 2, wherein the heating in the step of anaerobically heating the shredded product is to 600-1,000° C.

4. The process of claim 3, wherein heating in the step of anaerobically heating the shredded product is to 800° C.

5. The process of claim 2, wherein heating in the step of plasma heating is to 800-2,000° C.

6. The process of claim 5, wherein the plasma heating is to 1,400° C.

7. A recycled non sorted municipal waste composition, prepared according to the process of claim 1.

8. The composition of claim 7, comprising 30-40% w/w SiO₂, 30-40% w/w CaO, 5-10% w/w MgO, 3-5% w/w Fe₂O₃, 0-5% w/w ZnO, 0-5% w/w Al₂O₃, 0-5% w/w Na₂O, 0-5% w/w TiO₂, 0-5% w/w ZrO₂ and 0-5% w/w K₂O.

9. The composition of claim 8, wherein the composition is crystalline.

10. The composition of claim 8, wherein the composition does not comprise microscopic pores.

11. The composition of claim 8, wherein the composition has a tensile strength of above 2 MPa.

12. The composition of claim 8, wherein the composition has a specific thermal capacity of 1,000-1,500 J/Kg° C.

13. The composition of claim 12, wherein the specific thermal capacity is 1,100 J/Kg° C.

14. The composition of claim 8, wherein the composition is thermally stable until 1400° C.

15. The composition of claim 8, wherein the composition comprises particles having a diameter size of 0.1-15 cm.

16. The composition of claim 8, wherein the composition comprises diamond-shape particles.

17. The composition of claim 8, for use in thermal energy storage applications.

18. The composition of claim 17, wherein the thermal energy storage applications are selected from the group consisting essentially of: thermal batteries, water heater systems, air heater systems, solar or wind or geothermal or hydrothermal or nuclear power plants, industrial waste heat working according to Organic-Rankine-Cycle and intermittent energy buffer.

19. A thermal battery comprising the composition of claim 8.

20. An apparatus for storing and utilizing thermal energy, comprising the thermal battery of claim 19; a tubing within or surrounding the battery comprising a condensate inlet and a steam outlet; and, optionally, a tubing within or surrounding the battery, comprising an inlet and an outlet of a hot gas; wherein the steam exits the battery and enters a steam powered device and the condensate exits the steam powered device and enters the battery.
